(19) United States
(12) Patent Application Publication
(10) Pub. No.: US 2019/0289185 A1
(43) Pub. Date: Sep. 19, 2019

(54) OCCUPANT MONITORING APPARATUS

(71) Applicant: Yoshio Matsuura, Aichi (JP)

(72) Inventor: Yoshio Matsuura, Aichi (JP)

(73) Assignees: OMRON AUTOMOTIVE ELECTRONICS CO., LTD., Aichi (JP); Omron Corporation, Kyoto (JP)

(21) Appl. No.: 16/352,653

(22) Filed: Mar. 13, 2019

(30) Foreign Application Priority Data
Mar. 13, 2018 (JP) 2018-045239

(51) Int. Cl. H04N 5/235; B62D 15/02; G06K 9/00; G06T 5/50; G06K 9/20

(52) U.S. Cl. CPC H04N 5/2351; B62D 15/024; G06K 9/00255; G06T 5/50; G06T 2207/30268; G06K 9/00845; G06T 2207/20224; G06T 2207/30201; G06K 9/209

(57) ABSTRACT

An occupant monitoring apparatus includes: an imaging unit capturing an image of an occupant; an image processor performing predetermined processing on the image of the occupant captured by the imaging unit; and a sensitivity controller changing imaging sensitivity of the imaging unit. The occupant monitoring apparatus monitors the occupant according to the image of the occupant processed by the image processor. The imaging unit is disposed so as to face the occupant with a steering wheel located therebetween. In a case where the steering wheel is turned, the sensitivity controller maintains the current imaging sensitivity without changing the imaging sensitivity.

### CROSS-REFERENCE TO RELATED APPLICATION

This application is based on Japanese Patent Application No. 2018-045239 filed with the Japan Patent Office on Mar. 13, 2018, the entire contents of which are incorporated herein by reference.

### FIELD

The present invention relates to an occupant monitoring apparatus that captures an image of an occupant of a vehicle with an imaging unit and monitors the occupant, and in particular, to a technique of appropriately adjusting imaging sensitivity of the imaging unit.

### BACKGROUND

A driver monitor mounted on a vehicle is known as an apparatus for monitoring the condition of an occupant. The driver monitor is an apparatus that analyzes the image of the driver's face captured by an imaging unit (camera) and monitors the presence or absence of dozing driving and inattentive driving according to the eyelid closure degree, the sight line direction, and the like. Generally, an imaging unit of a driver monitor includes an imaging element capturing an image of the driver's face, and a light emitting element emitting light to the driver's face. JP 2010-50535 A discloses an example of such a driver monitor.

In many cases, an imaging unit of a driver monitor is installed together with a display panel, instruments, and the like on a dashboard or the like of the driver's seat of a vehicle. In a case where the imaging unit is disposed as described above, a steering wheel is interposed between the imaging unit and the driver, who is a subject. Therefore, when the driver turns the steering wheel, the imaging unit may be shielded by a spoke of the steering wheel or a hand of the driver. When the imaging unit is shielded, the captured image becomes a remarkably dark image (a remarkably bright image depending on the shielding object), which makes it difficult to accurately detect the face with appropriate luminance.

Conventionally, in the driver monitor, imaging sensitivity of the imaging unit is automatically adjusted according to luminance of the captured image. Specifically, in a case where an image is too dark, imaging sensitivity is increased to make the image brighter by extending exposure time of the imaging element or increasing light intensity of the light emitting element. In addition, a case where an image is too bright, imaging sensitivity is lowered to darken the image by shortening exposure time of the image imaging element or decreasing light intensity of the light emitting element.

However, even if the imaging unit is shielded by the spoke because the steering wheel is turned, in many cases, the imaging unit is released from being shielded when the spoke has passed over the imaging unit or the steering wheel is turned in the reverse direction. Thus, the condition of the image returns to the original condition. Therefore, in a case where the imaging unit is shielded by turning the steering wheel and the image becomes dark, if imaging sensitivity is immediately increased in response to this, at the time point when the shielded state is canceled, the image becomes too bright since the imaging sensitivity is high. As a result, trouble occurs in face detection. In addition, also in a case where the image becomes bright because the imaging unit is shielded, if imaging sensitivity is immediately lowered in response to this, at the time point when the shielded state is canceled, the image becomes too dark. As a result, trouble also occurs in face detection.

In a conventional driver monitor, even in a case where an imaging unit is temporarily shielded when the steering wheel is turned, imaging sensitivity is changed immediately as described above. Therefore, at the time point when the steering wheel is released from being shielded, an image with an appropriate luminance cannot be obtained. Therefore, it is difficult to detect a face. In this case, a sensitivity automatic adjustment function works to perform control to return the luminance to an appropriate value. However, it is inevitable that a time delay occurs in face detection until this control is completed.

Each of JP 2000-172966 A, JP 2010-11311 A, and JP 2009-201756 A discloses an occupant monitoring apparatus that detects a shielding object between an imaging unit and a subject and performs predetermined processing. In JP 2000-172966 A, in a case where an image of a spoke portion of a steering wheel is captured by an imaging unit, output of an alarm for the driver's driving condition is prohibited. In JP 2010-11311 A, in a case where a shielding object is detected between a vehicle and an object to be imaged, imaging is resumed on condition that it is determined that there is no shielding object thereafter. In JP 2009-201756 A, in such a case where an imaging unit is shielded by a steering wheel and the driver's face cannot be accurately detected, the cause of acquisition failure of face information is notified. However, neither of these documents proposes a solution to the above-described problem of sensitivity changing upon turning the steering wheel.

### SUMMARY

An object of the present invention is to provide an occupant monitoring apparatus capable of capturing an image of an occupant with appropriate luminance at the time point when an imaging unit is released from being shielded in a case where the imaging unit is temporarily shielded when a steering wheel is turned.

An occupant monitoring apparatus according to the present invention includes: an imaging unit disposed to face an occupant with a steering wheel located therebetween and configured to capture an image of the occupant; an image processor configured to perform predetermined processing on the image of the occupant captured by the imaging unit; and a sensitivity controller configured to change imaging sensitivity of the imaging unit. The occupant monitoring apparatus monitors the occupant according to an image of the occupant processed by the image processor. In the present invention, the sensitivity controller maintains current imaging sensitivity without changing the imaging sensitivity in a case where the steering wheel is turned.

According to such an occupant monitoring apparatus, even if the imaging unit is shielded by turning the steering wheel, the sensitivity controller does not change the imaging sensitivity of the imaging unit and maintains the current imaging sensitivity. Therefore, at a time point when the imaging unit is released from being shielded, the image of the occupant becomes an image with appropriate luminance which is neither too dark nor too bright and it is possible to accurately detect the face of the occupant or the like according to this image. Therefore, no time delay as in the conventional occupant monitoring apparatus occurs in detection of the face or the like, and occupant monitoring performance can be improved.

In the present invention, the sensitivity controller may maintain the current imaging sensitivity without changing the imaging sensitivity in a case where the steering wheel is turned and it is detected that the imaging unit is shielded.

In the present invention, after it is detected that the imaging unit is no longer shielded, the sensitivity controller may change the imaging sensitivity according to luminance of an image of the occupant.

In the present invention, the sensitivity controller may detect luminance of a specific region in which a specific part of the occupant is located in an image of the occupant, and may detect that the imaging unit is shielded according to the luminance of the specific region. In this case, the specific part may be a face of the occupant, and the specific region may be a face region in which the face is located.

In the present invention, the sensitivity controller may maintain the current imaging sensitivity without changing the imaging sensitivity in a case where the steering wheel is turned and a steering angle of the steering wheel is not less than a predetermined angle.

In the present invention, after the steering angle of the steering wheel becomes less than the predetermined angle, the sensitivity controller may change the imaging sensitivity according to luminance of an image of the occupant.

In the present invention, the predetermined angle may be a rotation angle from a reference position of the steering wheel in a case where a spoke of the steering wheel shields one of part and entirety of the imaging unit.

In the present invention, the sensitivity controller may detect that the steering wheel is turned according to an image obtained from the image processor.

In the present invention, the sensitivity controller may detect that the steering wheel is turned according to output of a steering angle sensor configured to detect a steering angle of the steering wheel.

According to the present invention, in a case where the imaging unit is temporarily shielded when the steering wheel is turned, an image of the occupant can be captured with appropriate luminance at the time point when the imaging unit is released from being shielded.

### BRIEF DESCRIPTION OF THE DRAWINGS

FIG. 1 is an electrical block diagram of a driver monitor according to an embodiment of the present invention.

FIG. 2 is a view illustrating a state in which an imaging unit captures an image of a face.

FIG. 3 is a front view of a steering wheel and the imaging unit.

FIGS. 4A to 4D are views for explaining how the steering wheel shields the imaging unit.

FIGS. 5A to 5C are views schematically illustrating examples of a conventional captured image.

FIGS. 6A to 6C are views schematically illustrating examples of a conventional captured image.

FIGS. 7A to 7C are views schematically illustrating examples of a captured image according to the present invention.

FIGS. 8A to 8C are views schematically illustrating examples of a captured image according to the present invention.

FIG. 9 is a flowchart illustrating an example of sensitivity control.

FIGS. 10A to 10C are views illustrating a face region and luminance distribution in a captured image.

FIG. 11 is a flowchart illustrating another example of the sensitivity control.

FIG. 12 is a view for explaining a steering angle of the steering wheel.

FIG. 13 is an electrical block diagram of a driver monitor according to another embodiment of the present invention.

### DETAILED DESCRIPTION

Hereinafter, embodiments of the present invention will be described with reference to the drawings. In the drawings, identical or corresponding parts are denoted by identical reference signs. Hereinafter, an example in which the present invention is applied to a driver monitor mounted on a vehicle will be described.

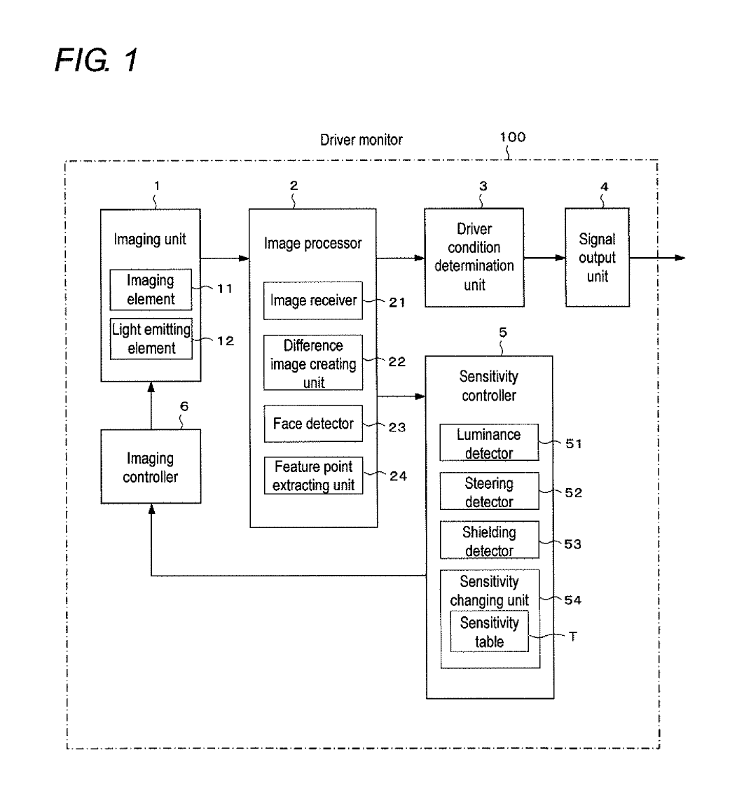

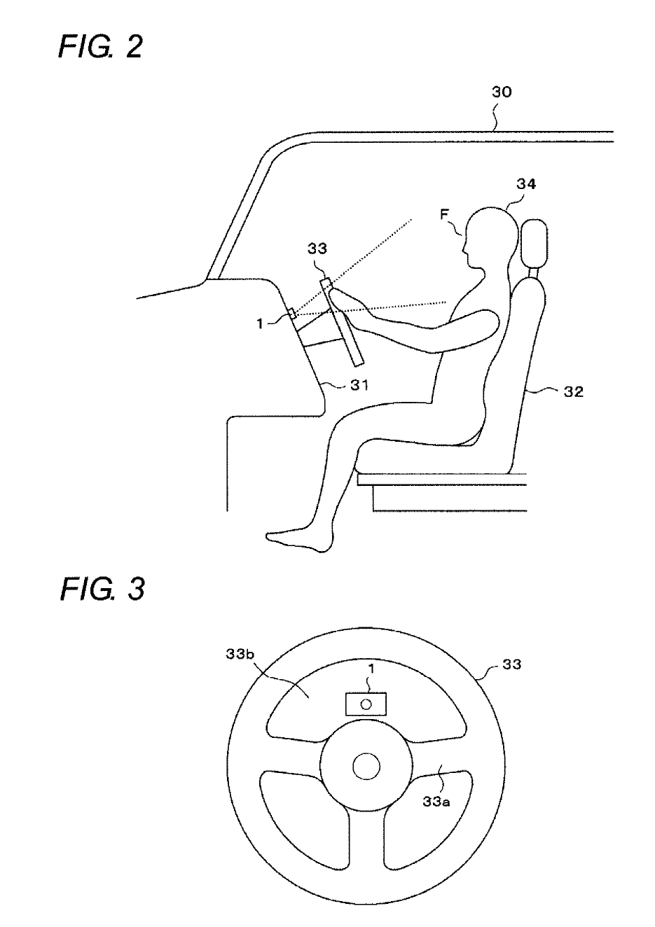

First, with reference to FIGS. 1 and 2, a configuration of the driver monitor will be described. In FIG. 1, a driver monitor 100 is mounted on a vehicle 30 in FIG. 2. The driver monitor 100 includes an imaging unit 1, an image processor 2, a driver condition determination unit 3, a signal output unit 4, a sensitivity controller 5, and an imaging controller 6.

The imaging unit 1 constitutes a camera, and includes an imaging element 11 and a light emitting element 12. The imaging unit 1 also includes an optical component such as a lens (not illustrated) in addition to the imaging element 11 and the light emitting element 12. The imaging element 11 is configured of, for example, a CMOS image sensor. The light emitting element 12 is configured of, for example, an LED that emits near-infrared light.

As illustrated in FIG. 2, the imaging unit 1 is disposed so as to face a driver 34 with a steering wheel 33 located therebetween, and captures an image of a face F of the driver 34 seated on a seat 32. Dotted lines indicate the imaging range of the imaging unit 1. The imaging unit 1 is provided on a dashboard 31 of a driver's seat together with a display and instruments, not illustrated. The imaging element 11 captures an image of the face F of the driver 34, and the light emitting element 12 irradiates the face of the driver 34 with near-infrared light. The driver 34 is an example of an “occupant” in the present invention.

In a case where the imaging unit 1 is installed as illustrated in FIG. 2, the steering wheel 33 is interposed between the imaging unit 1 and the face F of the driver 34. As illustrated in FIG. 3, the imaging unit 1 can capture an image of the face F through an opening 33b of the steering wheel 33. However, as will be described later, if the steering wheel 33 is turned, a spoke 33a of the steering wheel 33 may shield the imaging unit 1.

The imaging unit 1 creates a first image of the driver 34 captured in a state where the light emitting element 12 does not emit light and a second image of the driver 34 captured in a state where the light emitting element 12 emits light. The imaging unit 1 outputs the respective images to the image processor 2.

The image processor 2 includes an image receiver 21, a difference image creating unit 22, a face detector 23, and a feature point extracting unit 24. The image receiver 21 receives the first image and the second image output from the imaging unit 1 and temporarily stores the first image and the second image in an image memory, not illustrated. The difference image creating unit 22 creates a difference image which is difference between the second image and the first image. The face detector 23 detects the face F of the driver 34 according to the difference image. The feature point extracting unit 24 extracts feature points such as the eyes, the nose, and the mouth of the face F which is detected. By using the difference image, ambient light is removed and a clear face image with less luminance unevenness can be obtained.

According to the feature points of the face detected by the face detector 23 of the image processor 2 and the feature points of the face extracted by the feature point extracting unit 24, the driver condition determination unit 3 determines the face direction, the opening or closing state of the eyelids, the sight line direction, and the like of the driver 34, and determines the driving condition (dozing driving, inattentive driving, and the like) of the driver 34 according to the determination results.

The signal output unit 4 outputs the determination result of the driver condition determination unit 3 to an ECU (Electronic Control Unit), not illustrated. The ECU which is a host device is mounted on the vehicle 30 and is connected to the driver monitor 100 via a CAN (Controller Area Network).

The sensitivity controller 5 includes a luminance detector 51, a steering detector 52, a shielding detector 53, and a sensitivity changing unit 54.

The luminance detector 51 obtains the difference image created by the difference image creating unit 22 and detects the luminance of the difference image. The steering detector 52 detects that the steering wheel 33 is turned according to the difference image obtained from the difference image creating unit 22 and detects the steering angle of the steering wheel 33. The shielding detector 53 detects that the imaging unit 1 is shielded by the spoke 33a of the steering wheel 33, a hand of the driver 34, or the like, according to the difference image obtained from the difference image creating unit 22.

The sensitivity changing unit 54 changes the imaging sensitivity of the imaging unit 1 according to the luminance of the image detected by the luminance detector 51. That is, in a case where the luminance is too high, sensitivity is lowered so that the luminance is lowered, and in a case where the luminance is too low, sensitivity is increased so that the luminance increases. This is a normal sensitivity changing which is conventionally performed. In addition, the sensitivity changing unit 54 prohibits changing the imaging sensitivity, regardless of the luminance detected by the luminance detector 51, according to the detection results of the steering detector 52 and the shielding detector 53. This will be explained in detail later.

The sensitivity changing unit 54 is provided with a sensitivity table T. In this sensitivity table T, sensitivity levels in a plurality of stages and a sensitivity parameter set for each sensitivity level are stored (not illustrated). Examples of the sensitivity parameter include exposure time of the imaging element 11, a driving current of the light emitting element 12, and a gain of the imaging element 11. The sensitivity changing unit 54 changes the imaging sensitivity of the imaging unit 1 by referring to the sensitivity table T and selecting the sensitivity level and the sensitivity parameter corresponding to the sensitivity level which is selected.

The imaging controller 6 controls imaging operation of the imaging unit 1. Specifically, the imaging controller 6 controls the imaging timing of the imaging element 11 and the light emission timing of the light emitting element 12. In addition, the imaging controller 6 adjusts the imaging sensitivity of the imaging unit 1 according to the sensitivity parameter given from the sensitivity changing unit 54.

Note that even though the function of each of the difference image creating unit 22, the face detector 23, the feature point extracting unit 24, the driver condition determination unit 3, the luminance detector 51, the steering detector 52, the shielding detector 53, and the sensitivity changing unit 54 in FIG. 1 is actually realized by software, the function is illustrated by a hardware block diagram for the sake of convenience in FIG. 1.

Next, the basic mechanism of sensitivity control in the driver monitor 100 of the present invention will be described.

As illustrated in FIG. 3, in a state where the steering wheel 33 is not turned, the imaging unit 1 is not shielded by the spoke 33a and can capture an image of the face F of the driver 34 through the opening 33b.

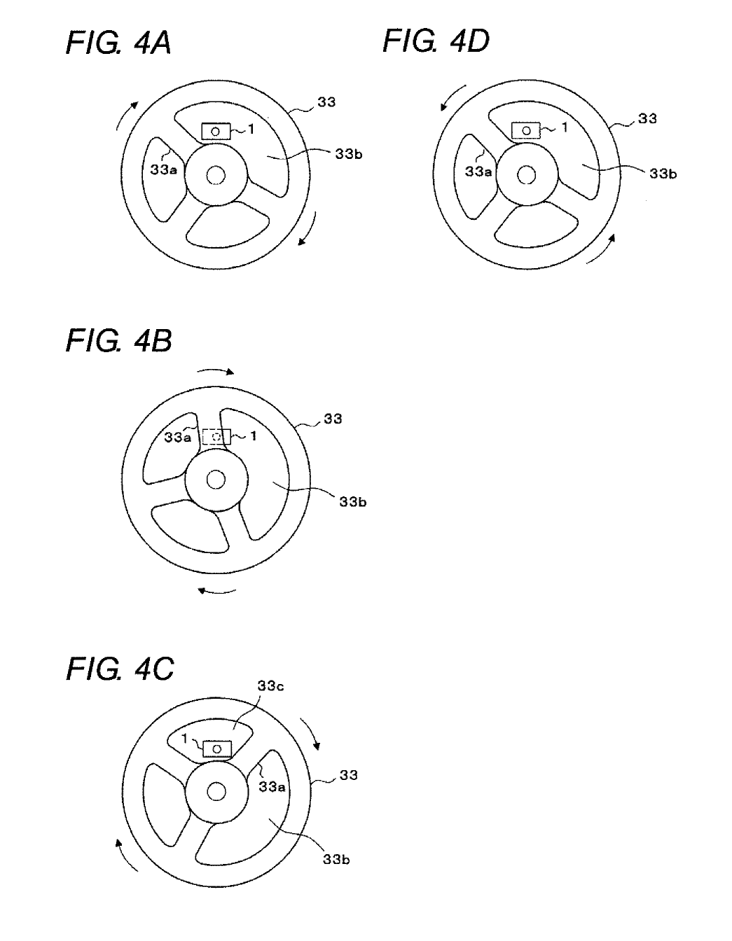

From this state, if the steering wheel 33 is turned in one direction (here, the right direction) as illustrated in FIG. 4A, the spoke 33a of the steering wheel 33 approaches the imaging unit 1. Then, as illustrated in FIG. 4B, if the steering wheel 33 is turned to a certain angle, the imaging unit 1 is shielded by the spoke 33a. Thereafter, as illustrated in FIG. 4C, if the steering wheel 33 is further turned, the spoke 33a passes over the imaging unit 1, the imaging unit 1 is released from being shielded, and the imaging unit 1 can capture an image through another opening 33c. In addition, even in a case where the steering wheel 33 is turned from the position of FIG. 4B in the reverse direction (here, the left direction) as illustrated in FIG. 4D, the spoke 33a is away from the imaging unit 1, the imaging unit 1 is released from being shielded, and the imaging unit 1 can capture an image through the opening 33b.

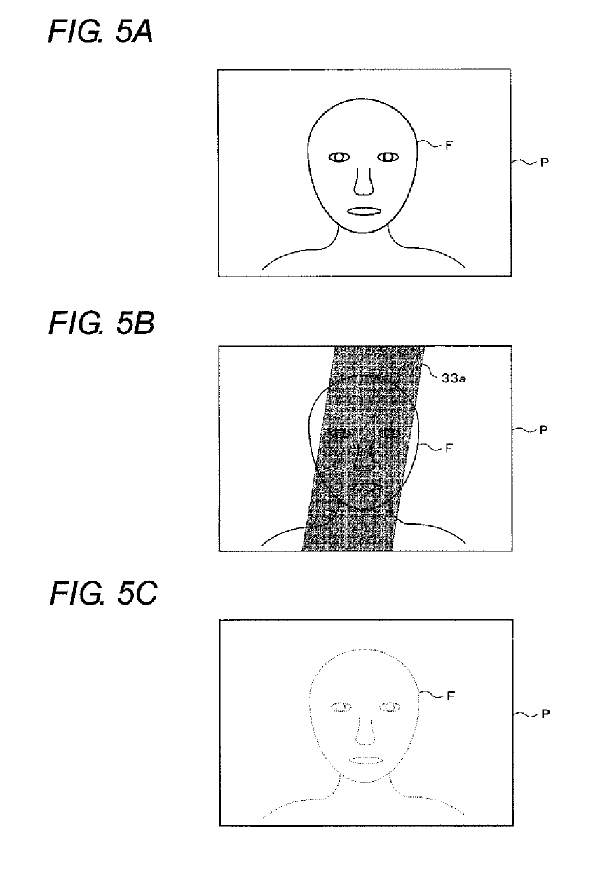

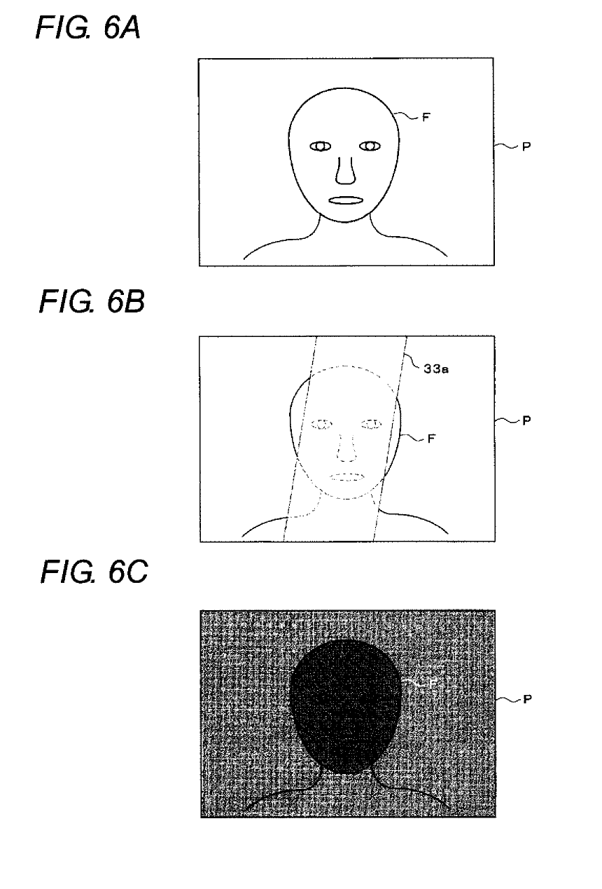

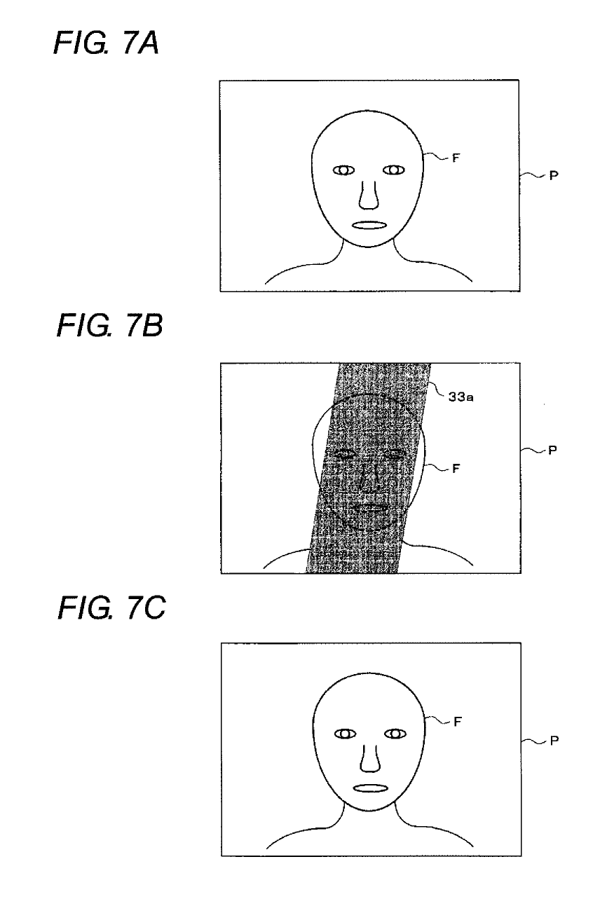

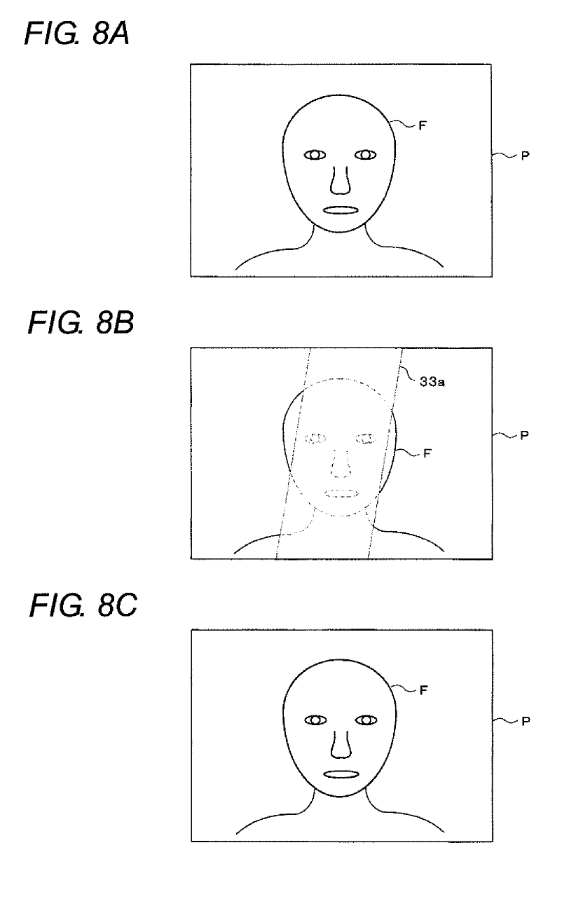

FIGS. 5A, 6A, 7A, and 8A, 5B, 6B, 7B, and 86, and 5C, 6C, 7C, and 8C illustrate examples of an image P (difference image) of the driver 34 in the states of FIGS. 4A, 4B, and 4C, respectively. FIGS. 5A to 6C are images in a conventional driver monitor, and FIGS. 7A to 8C are images in the driver monitor of the present invention.

In a case where the imaging unit 1 is shielded by the spoke 33a as illustrated in FIG. 4B, the portion of the image P corresponding to the spoke 33a becomes dark as illustrated in FIG. 5B or becomes bright as illustrated in FIG. 66. In either case, since the face F is covered with the spoke 33a, it is impossible to detect the face F. However, in the conventional driver monitor, in a case where the image P becomes dark as illustrated in FIG. 5B, imaging sensitivity of the imaging unit 1 is automatically increased, and in a case where the image P becomes bright as illustrated in FIG. 6B, imaging sensitivity of the imaging unit 1 is automatically lowered.

Then, at the time point of FIG. 4C when the imaging unit 1 is released from being shielded, since imaging sensitivity is high in the case of FIG. 5C, the image P at that time point becomes a too bright image illustrated in FIG. 5C. In contrast, in the case of FIG. 6C, since imaging sensitivity is low, the image P at the time point of FIG. 4C becomes a too dark image as illustrated in FIG. 6C. Therefore, in either case, it is difficult to accurately detect the face F from the image P.

Even though the sensitivity automatic adjustment function works to perform control for returning the luminance of the images P in FIGS. 5C and 6C to an appropriate value as described at the beginning, time delay occurs until this control is completed and the face F can be accurately detected. Therefore, the condition of the driver 34 cannot be properly determined during the above period, and the monitoring performance lowers.

In contrast, in the driver monitor 100 of the present invention, in both the case where the imaging unit 1 is shielded by the spoke 33a and the image P becomes dark as illustrated in FIG. 7B and the case where the image P becomes bright as illustrated in FIG. 8B, imaging sensitivity is not changed and the current imaging sensitivity is maintained. Therefore, in a case where the image P becomes dark as illustrated in FIG. 7B, the imaging sensitivity does not increase. As a result, the image P at the time point of FIG. 4C when the imaging unit 1 is released from being shielded is an image with appropriate luminance which is not too bright as illustrated in FIG. 7C. In addition, in a case where the image P becomes bright as illustrated in FIG. 8B, imaging sensitivity is not lowered. As a result, the image P at the time point of FIG. 4C when the imaging unit 1 is released from being shielded is an image with appropriate luminance which is not too dark as illustrated in FIG. 8C. As described above, in the case of the present invention, it is possible to accurately detect the face F of the driver 34 according to the image with appropriate luminance at the time point when the imaging unit 1 is released from being shielded. Therefore, no time delay occurs in detection of the face F, and the monitoring performance is improved.

Note that in FIGS. 4A to 4D, in a case where the steering wheel 33 is turned in the reverse direction (left direction) from the position of FIG. 4C, the imaging unit 1 is shielded again by the spoke 33a. However, also at this time, imaging sensitivity is not changed.

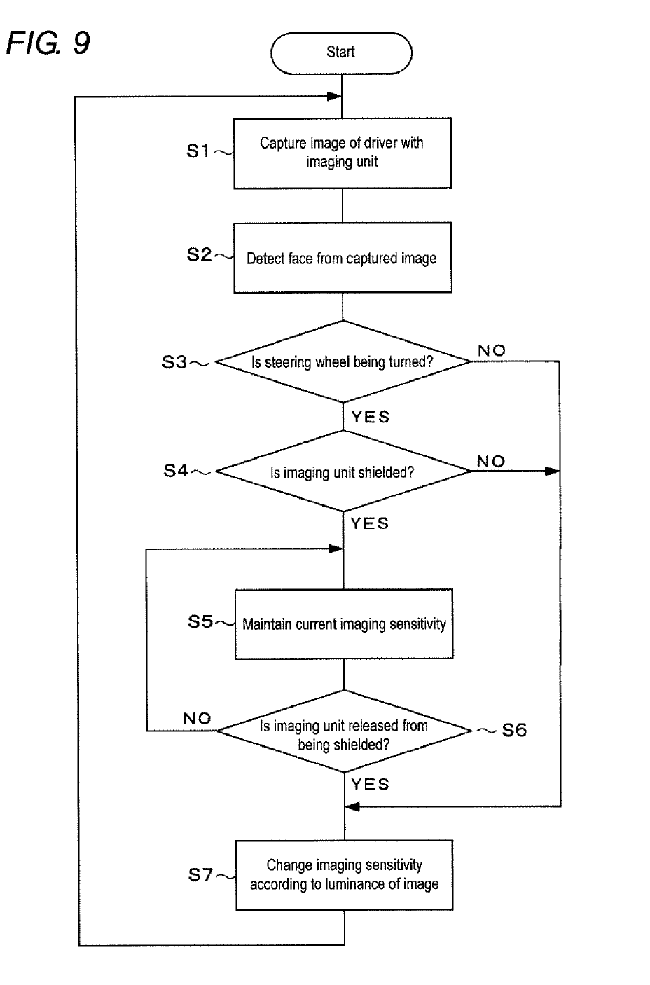

Next, details of sensitivity control in the driver monitor 100 of the present invention will be described. FIG. 9 is a flowchart illustrating an example of the sensitivity control.

In FIG. 9, in step S1, the imaging unit 1 captures an image of the driver 34 under control of the imaging controller 6. In this case, a first image captured in a state where the light emitting element 12 does not emit light and a second image captured in a state where the light emitting element 12 emits light are obtained.

In step S2, the face detector 23 of the image processor 2 detects the face F of the driver 34 from the difference image (difference between the second image and the first image) created by the difference image creating unit 22. In addition, even though not illustrated in FIG. 9, the feature point extracting unit 24 of the image processor 2 extracts feature points of the face F.

In step S3, the steering detector 52 of the sensitivity controller 5 determines whether or not the steering wheel 33 is being turned, that is, whether the steering wheel 33 is rotated in the right or left direction from the reference position illustrated in FIG. 3. As described above, whether or not the steering wheel 33 is turned can be determined according to the difference image obtained from the difference image creating unit 22.

As a result of the determination in step S3, in a case where the steering wheel 33 is being turned (step S3: YES), the process proceeds to step S4, whereas in a case where the steering wheel 33 is not being turned (step S3: NO), the process proceeds to step S7. In step S7, the sensitivity changing unit 54 changes the imaging sensitivity of the imaging unit 1 according to the luminance of the image detected by the luminance detector 51 (normal sensitivity changing).

In step S4, the shielding detector 53 of the sensitivity controller 5 determines whether or not the imaging unit 1 is shielded. As described above, the shielding detector 53 can determine whether or not the imaging unit 1 is shielded according to the difference image obtained from the difference image creating unit 22.

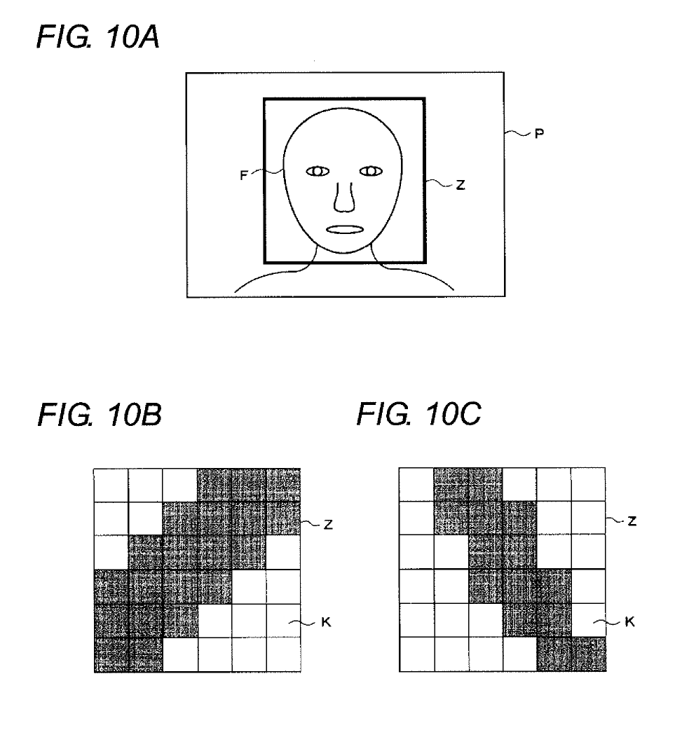

For example, as illustrated in FIG. 10A, it is possible to detect the luminance of a face region Z in which the face F of the driver 34 is located in the image P (difference image), and to detect that the imaging unit 1 is shielded according to the luminance of the face region Z. Specifically, as illustrated in FIGS. 10B and 10C, the luminance of each pixel block K (block including a plurality of pixels) constituting the face region Z is detected. In such a case where pixel blocks K having extremely low (or high) luminance such that the pixel blocks K look like to be painted out are successive in a predetermined pattern, it is determined that the imaging unit 1 is shielded. Note that the entire face F is not necessarily shielded on the image P. Even in a case where only part of the face F is shielded, it may be determined that the imaging unit 1 is shielded.

As a result of the determination in step S4, in a case where the imaging unit 1 is shielded (step S4: YES), the process proceeds to step S5, whereas in a case where the imaging unit 1 is not shielded (step S4: NO), the process proceeds to step S7.

In step S5, the sensitivity changing unit 54 of the sensitivity controller 5 maintains the current imaging sensitivity without changing the imaging sensitivity of the imaging unit 1. That is, the imaging sensitivity remains unchanged after the imaging sensitivity was changed last time. Then, in the next step S6, the shielding detector 53 determines whether the imaging unit 1 is released from being shielded. This determination can also be made according to the difference image.

As a result of the determination in step S6, if the imaging unit 1 is not released from being shielded (step S6: NO), the process returns to step S5 and the current imaging sensitivity is maintained. In contrast, if the imaging unit 1 is released from being shielded (step S6: YES), the process proceeds to step S7, and the imaging sensitivity of the imaging unit 1 is changed according to the normal sensitivity changing. After execution of step S7, the process returns to step S1 and the series of operations described above will be executed.

According to the embodiment described above, even if the spoke 33a shields the imaging unit 1 because the steering wheel 33 is turned, the sensitivity controller 5 does not cause the sensitivity changing unit 54 to change the imaging sensitivity of the imaging unit 1 and maintains the current imaging sensitivity. Therefore, at a time point when the imaging unit 1 is released from being shielded, the image P becomes an image with appropriate luminance which is neither too dark nor too bright and it is possible to accurately detect the face F of the driver 34 according to this image. Therefore, no conventional time delay occurs in detection of the face F, and the monitoring performance for the driver 34 can be improved.

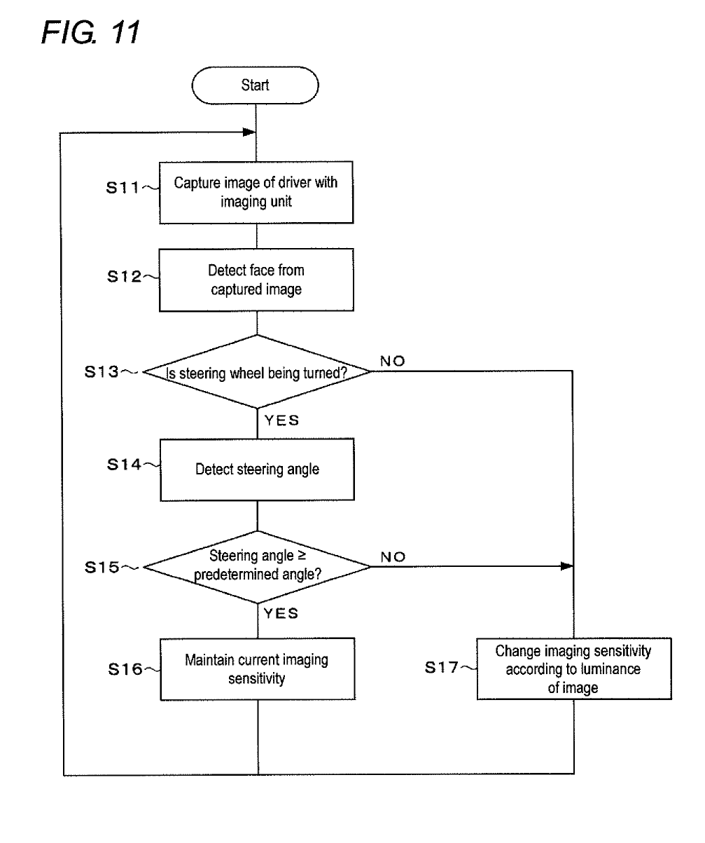

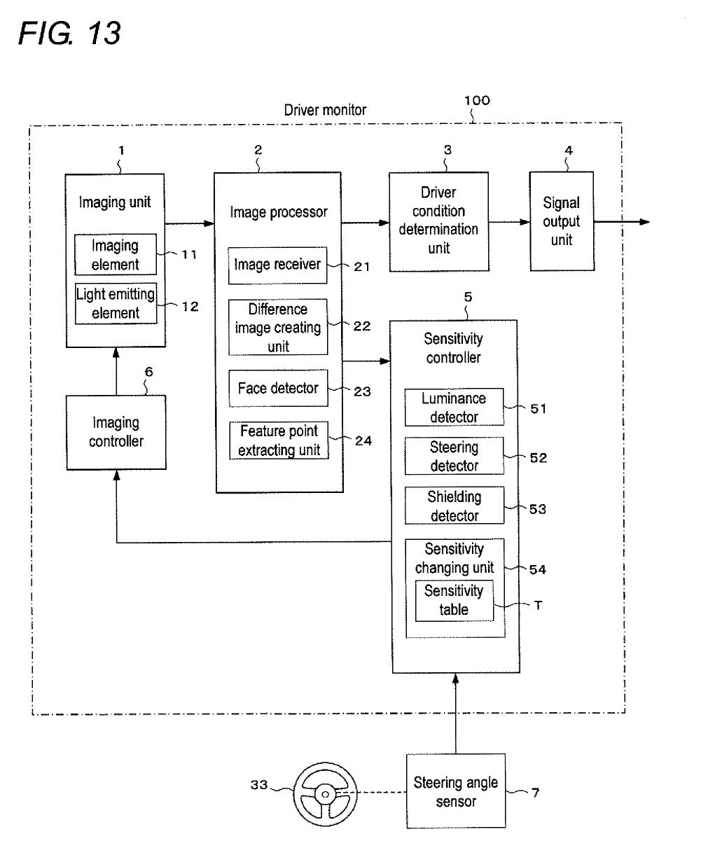

FIG. 11 is a flowchart illustrating another example of the sensitivity control. The configuration of the driver monitor 100 is identical to the configuration in FIG. 1 (or FIG. 13 to be described later).

In FIG. 11, in step S11, processing identical to processing in step S1 in FIG. 9 is executed, and the imaging unit 1 captures an image of the driver 34 under control of the imaging controller 6. In step S12, processing identical to the processing in step S2 in FIG. 9 is executed, and the face detector 23 of the image processor 2 detects the face F of the driver 34 from the difference image.

In step S13, processing identical to the processing in step S3 in FIG. 9 is executed, and the steering detector 52 determines whether the steering wheel 33 is being turned or not. As a result of the determination, if the steering wheel 33 is being turned (step S13: YES), the process proceeds to step S14, whereas if the steering wheel 33 is not being turned (step S13: NO), the process proceeds to step S17. In step S17, the sensitivity changing unit 54 changes the imaging sensitivity of the imaging unit 1 according to the luminance detected by the luminance detector 51 (normal sensitivity changing).

In step S14, the steering detector 52 detects the steering angle of the steering wheel 33. The steering detector 52 can detect the steering angle according to the difference image.

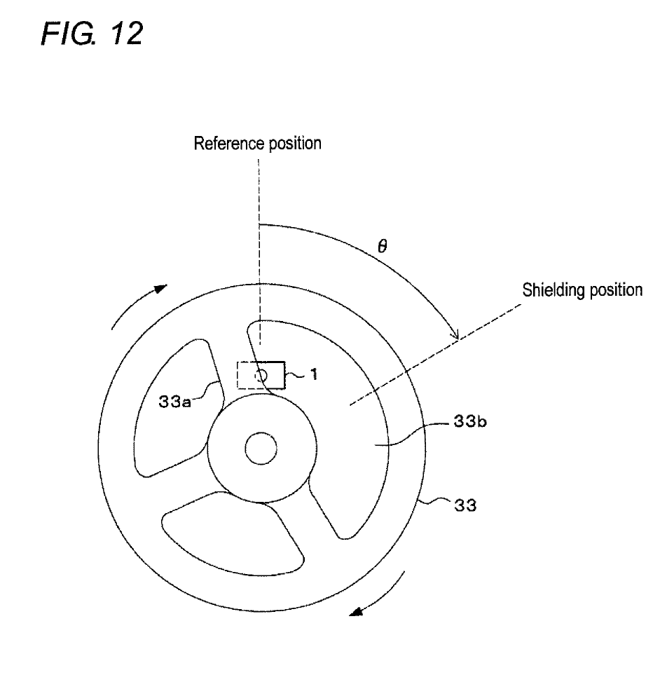

In step S15, the steering detector 52 determines whether or not the steering angle detected in step S14 is equal to or greater than a predetermined angle. The predetermined angle in this case is set, for example, to a steering angle θ (rotation angle from the reference position) of the steering wheel 33 when the spoke 33a shields part (or entirety) of the imaging unit 1, as illustrated in FIG. 12. Therefore, the determination in step S15 is also a determination as to whether or not the spoke 33a shields the imaging unit 1.

Until the steering angle reaches the predetermined angle (step S15: NO), it is determined that the spoke 33a does not shield the imaging unit 1, and the process proceeds to step S17. If the steering angle reaches the predetermined angle (step S15: YES), it is determined that the spoke 33a shields the imaging unit 1, and the process proceeds to step S16.

In step S16, the sensitivity changing unit 54 of the sensitivity controller 5 maintains the current imaging sensitivity without changing the imaging sensitivity of the imaging unit 1. That is, the imaging sensitivity remains unchanged after the imaging sensitivity was changed last time. After steps S16 and S17 are executed, the process returns to step S11.

According to the above-described embodiment of FIG. 11, whether or not the imaging unit 1 is shielded by the spoke 33a is determined according to the steering angle of the steering wheel 33. Therefore, the embodiment is advantageous in that it is not necessary to analyze an image to determine whether or not the imaging unit 1 is shielded as in step S4 in FIG. 9, and processing of determining whether or not the imaging unit 1 is shielded is simplified.

FIG. 13 illustrates a driver monitor 100 according to another embodiment of the present invention. In FIG. 13, parts identical to those in FIG. 1 are denoted by identical reference signs.

In the driver monitor 100 in FIG. 1 described above, the steering detector 52 of the sensitivity controller 5 detects that the steering wheel 33 is turned according to the difference image obtained from the image processor 2. In contrast, in the driver monitor 100 in FIG. 13, a steering detector 52 of a sensitivity controller 5 detects that a steering wheel 33 is turned according to output of a steering angle sensor 7 which detects the steering angle of the steering wheel 33. Since the configuration other than the above point is identical to the configuration in FIG. 1, the description of the portions overlapping with those in FIG. 1 will be omitted.

According to the driver monitor 100 of FIG. 13, since the steering detector 52 does not need to analyze an image in order to detect whether or not the steering wheel 33 is turned, the driver monitor 100 of FIG. 13 is advantageous in that steering detection processing is simplified.

In the present invention, in addition to the embodiments described above, various embodiments described below can be adopted.

In the above embodiments, by using the difference image created by the image processor 2, the face F is detected and it is detected that the imaging unit 1 is shielded; however, the present invention is not limited thereto. For example, in lieu of the difference image, the above-described first image or second image captured by the imaging unit 1 may be used to detect a face F and to detect that the imaging unit 1 is shielded.

In the above embodiments, the case where the spoke 33a of the steering wheel 33 shields the imaging unit 1 has been described as an example. However, the imaging unit 1 may be shielded by a hand of the driver 34 gripping the steering wheel 33. According to the present invention, even in such a case, it is possible to perform control similar to the control performed in the case where the spoke 33a shields the imaging unit 1.

In the above embodiments, in the case where the steering wheel 33 is turned and it is detected that the imaging unit 1 is shielded (steps S3 and S4 of FIG. 9), or in a case where the steering wheel 33 is turned and the steering angle is equal to or greater than the predetermined angle (steps S13 and S15 of FIG. 11), the imaging sensitivity is not changed and the current imaging sensitivity is maintained. However, the present invention is not limited thereto. For example, imaging sensitivity may not be changed and current imaging sensitivity may be maintained only on condition that it is detected that the steering wheel 33 is turned.

In the above embodiments, an example in which the face region Z in the image is a quadrangle has been described (FIG. 10). However, the present invention is not limited thereto, and a face region Z may be a rhomboid, an ellipse, a circle, or the like.

In the above embodiments, the occupant is the driver 34, the specific part of the occupant is the face F, and the specific region in the image of the occupant is the face region Z. However, the present invention is not limited thereto. The occupant may be a person other than a driver, the specific part of the occupant may be a part other than the face, and the specific region may be a region in which a part other than the face is located.

In the above embodiments, the driver monitor 100 mounted on the vehicle is described as an example of the occupant monitoring apparatus of the present invention. However, the present invention can also be applied to an occupant monitoring apparatus mounted on a conveyance other than a vehicle.

1. An occupant monitoring apparatus comprising:
an imaging unit disposed to face an occupant with a steering wheel located therebetween and configured to capture an image of the occupant;
an image processor configured to perform predetermined processing on the image of the occupant captured by the imaging unit; and
a sensitivity controller configured to change imaging sensitivity of the imaging unit,
the occupant monitoring apparatus monitoring the occupant according to an image of the occupant processed by the image processor,
wherein the sensitivity controller maintains current imaging sensitivity without changing the imaging sensitivity in a case where the steering wheel is turned.

2. The occupant monitoring apparatus according to claim 1, wherein the sensitivity controller maintains the current imaging sensitivity without changing the imaging sensitivity in a case where the steering wheel is turned and it is detected that the imaging unit is shielded.

3. The occupant monitoring apparatus according to claim 2, wherein after it is detected that the imaging unit is no longer shielded, the sensitivity controller changes the imaging sensitivity according to luminance of an image of the occupant.

4. The occupant monitoring apparatus according to claim 2, wherein the sensitivity controller detects luminance of a specific region in which a specific part of the occupant is located in an image of the occupant, and detects that the imaging unit is shielded according to the luminance of the specific region.

5. The occupant monitoring apparatus according to claim 4, wherein the specific part is a face of the occupant, and the specific region is a face region in which the face is located.

6. The occupant monitoring apparatus according to claim 1, wherein the sensitivity controller maintains the current imaging sensitivity without changing the imaging sensitivity in a case where the steering wheel is turned and a steering angle of the steering wheel is not less than a predetermined angle.

7. The occupant monitoring apparatus according to claim 6, wherein after the steering angle of the steering wheel becomes less than the predetermined angle, the sensitivity controller changes the imaging sensitivity according to luminance of an image of the occupant.

8. The occupant monitoring apparatus according to claim 6, wherein the predetermined angle is a rotation angle from a reference position of the steering wheel in a case where a spoke of the steering wheel shields one of part and entirety of the imaging unit.

9. The occupant monitoring apparatus according to claim 1, wherein the sensitivity controller detects that the steering wheel is turned according to an image obtained from the image processor.

10. The occupant monitoring apparatus according to claim 1, wherein the sensitivity controller detects that the steering wheel is turned according to output of a steering angle sensor configured to detect a steering angle of the steering wheel.
